(19) United States
(12) Patent Application Publication
(10) Pub. No.: US 2020/0392378 A1
(43) Pub. Date: Dec. 17, 2020

(54) ADHESIVE TAPE WITH STRIP TO HELP LOCATE AND LIFT THE LEADING EDGE, AND METHODS OF MANUFACTURING SAME

(71) Applicant: Richard William Schofield, Redding, CA (US)

(72) Inventor: Richard William Schofield, Redding, CA (US)

(21) Appl. No.: 16/946,295

(22) Filed: Jun. 15, 2020

Related U.S. Application Data
(60) Provisional application No. 62/862,637, filed on Jun. 17, 2019.

(51) Int. Cl. C09J 7/29; B41J 3/407

(52) U.S. Cl. CPC C09J 7/29; B41J 3/4075; C08K 3/013; C08K 2201/013; C09J 2205/102

(57) ABSTRACT

Adhesive tape on a roll having a functional strip running the length of the tape, wherein a color gradient is visible on the top side such that the functional strip at the leading edge always appears different to the layer of tape below, to which it adheres on the roll, facilitating the location the leading edge. Furthermore, the adhesiveness of the tape is reduced on the underside within the area of the functional strip, facilitating the lifting and peeling of the leading edge at that point. Methods of manufacture are disclosed, including use of an inkjet printer to print a layer of ink with a color gradient directly onto the adhesive side of a transparent tape, the color gradient being visible through the tape, and the layer of ink accomplishing the reduction in adhesiveness.

### REFERENCE TO RELATED APPLICATIONS

This application claims an invention which was disclosed in Provisional Application No. 62/862,637, filed Jun. 17, 2019, entitled “Adhesive Tape with Enhanced Features”. The benefit under 35 USC § 119(e) of the United States provisional application is hereby claimed, and the aforementioned application is hereby incorporated herein by reference.

### BACKGROUND OF THE INVENTION

### 1. Field of the Invention

The present invention relates to the field of pressure-sensitive adhesive tape, and especially to packaging tape, and also relates to the manufacturing techniques therefor. More specifically, the present invention relates to enhancing rolls of pressure-sensitive tape by modifying the appearance and/or adhesiveness in order to make it easier to 1) locate the leading edge on the roll of tape, and 2) lift the leading edge to begin peeling tape from the roll.

### 2. Description of the Prior Art

One of the most common forms of adhesive tape is pressure-sensitive tape, which comprises a backing film coated on one side (or both) with an adhesive compound that is pressure sensitive, meaning that the more firmly you press on it, the better it adheres. This is in contrast to, for example, heat- or water-activated adhesives, where application pressure is not the primary method of achieving adhesion.

Pressure-sensitive adhesive tape was developed for commercial use in the 1920s and 1930s. Since then, it has become widely used for household, commercial and industrial applications. While pressure sensitive tapes come in many forms, this invention relates more to rolls of single-sided tape with a polymeric-film backing, such as packaging tape (also known as shipping tape, packing tape, box-sealing tape, etc.) and “sticky” tape, such as Scotch tape and Magic tape.

Pressure-sensitive tape has been adapted over many decades for specific applications, however one common problem persists to this day. When a length of tape is cut from the roll for use, the remaining tape sticks back onto the roll. Upon next use of the roll of tape, it is difficult to find the leading edge, particularly if the tape is thin and transparent and the cut was clean. Furthermore, once located, it can be difficult to lift the leading edge to begin peeling. Anyone who has packed their belongings in boxes for moving or storage is very familiar with these vexations.

One solution to this problem is the use of a tape dispenser, which typically includes a serrated cutting blade to which the leading edge adheres. While desk-mounted dispensers generally work well for sticky tape in an office or home environment, hand-held dispensers for box-sealing can be frustrating and unwieldy, especially when the leading edge breaks free from the blade and reattaches to the roll. Many casual or intermittent user of packaging tape, such as home or small business users, do not use a dispenser for packaging tape due to this unwieldiness.

There have been prior attempts to solve the two problems of firstly, locating the leading edge, and secondly, lifting the leading edge to peel it. An example relating to finding the leading edge is U.S. Pat. No. 7,615,280 (Behravesh, 2009), which describes the use of a light emitter to make the leading edge of the tape glow. This may be very effective, but is unlikely to be of affordable and practical utility for household or office use of packaging tape. Similarly, U.S. Pat. No. 6,767,628 (Posa, 2004) describes tape containing a reactive or fluorescent die that develops a noticeable color on exposure to air and/or moisture as a way of finding the leading edge. This approach has not found widespread application, perhaps because the very thin strip of coloration so produced may still be difficult to locate. The technique described in the present invention for locating the leading edge addresses the same problem as these two inventions, but accomplishes the result by an entirely different method—one that is reliable, easy to use, and affordable to produce.

As an example relating to lifting and peeling the leading edge, U.S. Pat. No. 10,259,679 (Kirill, 2019) describes a device for separating, saving and storing an adhesive tape leading edge. While this device attempts to address the current problem, it still requires you to find the leading edge, and begin peeling the leading edge in order to use the device. The present invention would greatly enhance the usability of Kirill's invention, but also makes it redundant.

As an example of a similar problem being solved, U.S. Pat. No. 5,340,629 (Rodighiero, 1994) describes tape with no adhesive along a wide strip on both edges specifically developed for surgical-tape applications. It allows the user to easily begin peeling the tape even when wearing surgical gloves. The complete absence of adhesive along each edge in Rodighiero's invention would not bear good results for general tape use and especially for packaging tape, as the loose edges could get caught in package-handling equipment. Furthermore, the added film that Rodighiero uses to deaden the adhesiveness along the edges of the tape would prevent the tape from rolling up well on a core during manufacture. The present invention makes it easier to lift the leading edge of tape in a way that will not result in negative implications in normal production and use.

Many brands and formats of commercial tape have a colored, non-adhesive tab at the leading edge of a brand-new roll of unused tape to provide the functionality of the present invention, however, once the first piece of tape has been cut from the roll, that functionality is no longer available. The present invention provides this functionality at all points along the length of tape.

### SUMMARY OF THE INVENTION

This invention is an enhancement to conventional adhesive tape, such as packaging tape, wherein the base tape is modified to provide a functional strip that makes it easy to 1) find the leading edge on the roll of tape, and 2) lift and peel the leading edge to dispense more tape.

The first of these benefits is achieved by making the functional strip have a modified appearance, which comprises two components: a) a contrasting appearance, and b) a changing appearance in the longitudinal direction. The contrasting appearance refers to the functional strip being visually discernable from the base tape adjacent to it (which is not within the functional strip). The changing appearance in the longitudinal direction refers to a continual change in appearance of the functional strip along the tape's length, such that it has a noticeable change in appearance for each revolution of the tape as it is wound around the core. As such, the top layer of tape has a different appearance to the layer below it within the functional strip, thereby making the leading edge stand out.

The second benefit—making it easier to lift and peel the leading edge—is accomplished by reducing the adhesiveness of the tape within the functional strip. The fact that the functional strip has a contrasting appearance to the tape adjacent to it allows the user to identify where the adhesiveness has been reduced on the opposite side, and hence where it will be easiest to lift and peel the tape. Either of these features can be created and used on a stand-alone basis with partial utility, or they can be created and used jointly for full effect.

This invention also includes methods for manufacturing the desired product. One preferred method is to print a colored ink strip on the underside of a transparent adhesive tape, said strip (which is visible through the tape backing) being visually distinct from the layer below it on the roll. Furthermore, the ink layer so printed coincidentally produces the desired reduction in adhesiveness of the tape within the strip.

### BRIEF DESCRIPTION OF THE DRAWINGS

FIG. 1 shows a roll of adhesive tape incorporating a functional strip.

FIG. 2 shows use of the present invention employing a fingernail to peel the tape.

FIG. 3 shows a manufacturing process for the present invention employing a non-contact printer head to print the functional strip.

FIG. 4 shows a process using a printing device to indirectly print the functional strip.

FIG. 5 shows use of an ink-transfer wheel to deliver the printed ink to the adhesive side of the tape.

FIG. 6 shows how to use traditional flexographic printing techniques to create a printed strip for the present invention.

FIG. 7 shows variations in the positioning of the functional strip.

### DETAILED DESCRIPTION

### 1. Detailed Description of the Drawings

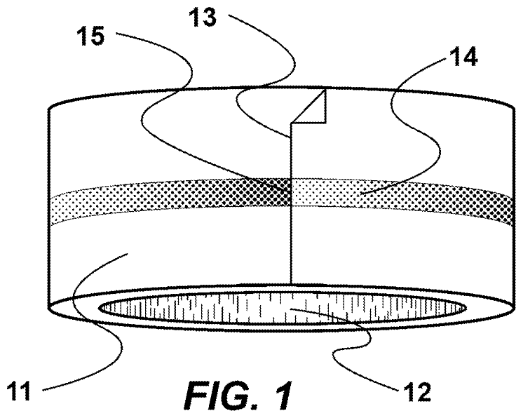

One preferred embodiment of this invention is shown in FIG. 1. Adhesive tape consisting of a film or backing with an adhesive layer on the underside, is produced as a roll of tape 11 on a cardboard core 12. When a piece of tape has been cut from the roll, the leading edge 13 can re-stick to the roll, making it difficult to locate and peel from the roll upon next use. A functional strip 14 runs the length of the tape, more-or-less centered laterally on the tape. From above, the functional strip 14 has a changing appearance in the longitudinal direction, creating a noticeably different appearance between the leading edge 15 and the layer of tape below, to which it sticks. This noticeably different appearance makes it easy to locate the leading edge of the tape 15.

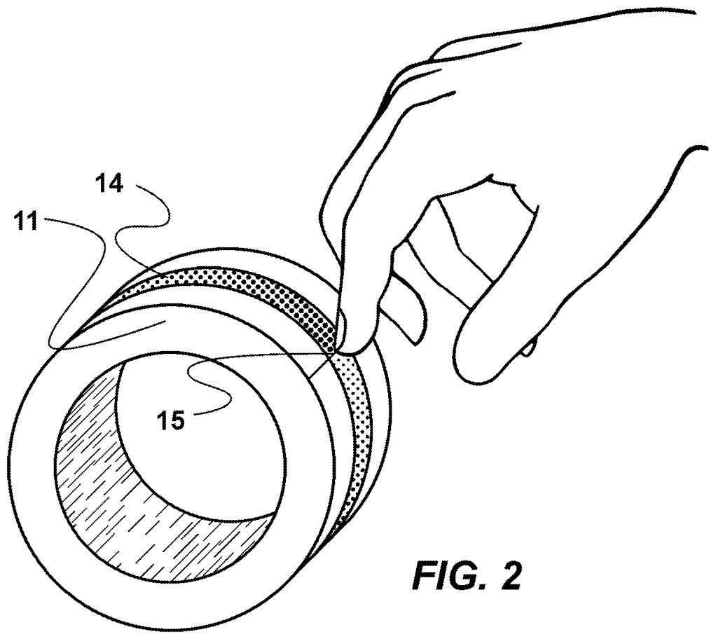

As shown in FIG. 2, when using a roll of tape 11 in this preferred embodiment, the functional strip 14 performs a second function. On the underside, the tape has reduced adhesiveness within the area of the functional strip 14, making it easier to get a fingernail (or other utensil) under the leading edge 15 to begin peeling the tape. In order to know where, on the underside, the adhesiveness has been reduced, the functional strip 14 should have a contrasting appearance to the rest of the tape.

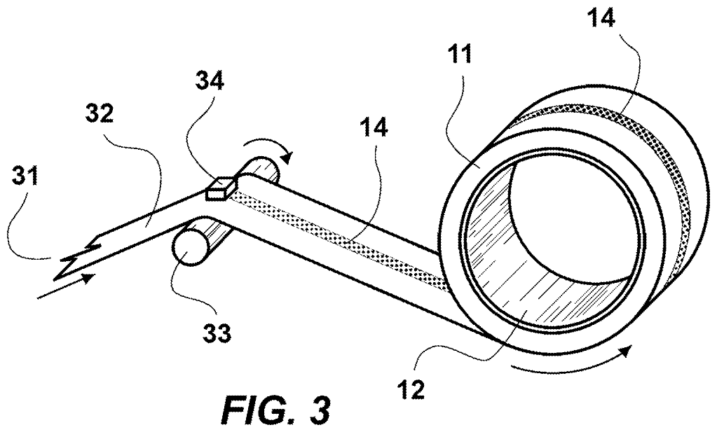

FIG. 3 shows a basic manufacturing process for the present invention, as applied to a base tape which is, for example, a transparent packaging tape that has already had the adhesive layer applied to the backing layer in any conventional manufacturing process. The unrolled base tape 31, with the adhesive side 32 facing up, passes over a rotating roller 33. A printer head 34 is positioned above the roller at the center of the tape, and deposits a strip of ink 14 with longitudinally varying appearance to form the functional strip 14. This printer head could, for example, be an inkjet printer head positioned with a 1 mm gap between it and the moving adhesive layer below. The tape is then wound on a cardboard core 12 to form a roll of tape 11 incorporating the functional strip 14. The layer of ink simultaneously creates the two required elements of the preferred embodiment, namely 1) the reduced adhesiveness, and 2) the modified appearance, which itself consists of two components: a) a contrasting appearance between the functional strip and the tape adjacent to it, and b) a changing appearance in the longitudinal direction, the rate of change of which ensures that the functional strip, at any point along the tape, appears noticeably different from the layer of tape below.

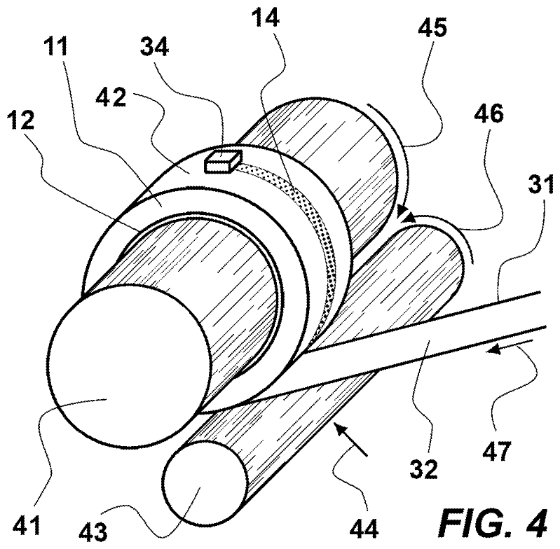

FIG. 4 shows a modified manufacturing process where the ink is printed initially onto the non-adhesive backing side of the tape, and then transferred to the adhesive side of the tape. The base tape 31 is wound onto a cardboard core 12 rotating on a drive shaft 41. The adhesive side of the tape 32 feeds onto the roll of tape, leaving the non-adhesive backing 42 exposed on the outside of the roll 11. A pressure roller 43 is positioned so that it provides force 44 on the strip of tape 31 as it makes contact with the roll 11. The rotation 45 of the drive shaft 41 is counter-directional to the rotation 46 of the pressure roller 43, and their speeds of rotation are such that the liner surface velocities of the drive shaft 41 and pressure roller 43 match the speed 47 of the incoming tape 31. A printer head 34 is positioned to print a strip of ink 14 along the center of the tape backing 42 as the tape rolls up. As the roll of tape 11 winds up, the adhesive side 32 of the incoming tape 31 makes contact with the printed strip 14 on the outer surface of the roll. The ink layer that comprises the printed strip 14 has been deposited on the outer surface of the tape 42, but does not bond permanently in that position. When the strip of ink 14 comes into contact with the adhesive side 32 of the incoming tape, it releases from the tape backing and bonds permanently to the adhesive side 32 of the tape. Pressure 44 from the pressure roller 43 provides two functions: firstly, it provides extra driving force for the transfer of the microns-thick ink strip 14 from its initial location on the tape backing 42 to the adhesive side 32 of the incoming tape; and secondly, it provides sufficient force to slightly compress and redistribute the composite region of adhesive and ink so formed to prevent that region from bulging as the roll of tape is wound up.

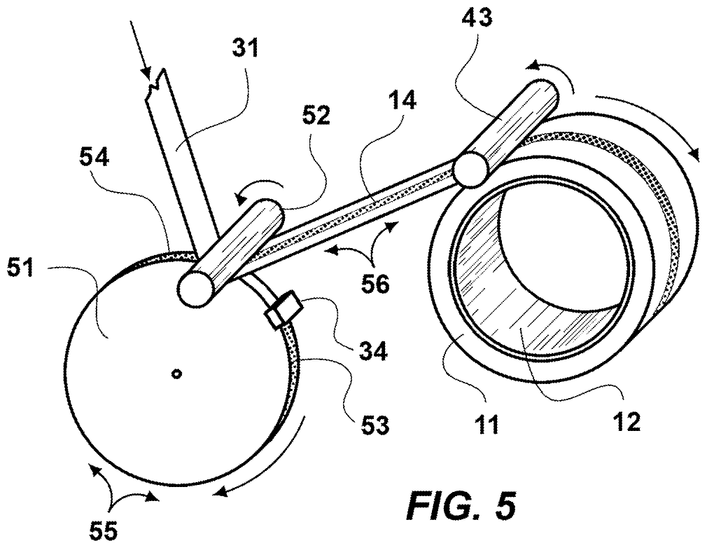

FIG. 5 shows another example process for depositing a printed layer of ink on the adhesive side of a roll of transparent tape thereby forming the functional strip. This process takes a more-or-less steady feed of adhesive base tape 31 and feeds it between an ink-transfer wheel 51 and a pressure roll 52, both of which rotate to match the linear speed of the incoming tape. An inkjet printer head 34, or any other printing technology, deposits a printed pattern 53 onto the outer circumferential surface of the ink-transfer wheel. The size and rotation rate of the ink-transfer wheel are such that the ink has sufficient time to reach a suitable degree of dryness before it completes its single rotation and comes into contact with the tape. The ink with a degree of dryness 54, is brought into intimate contact with the adhesive side of the tape under the pressure roll 52. The surface of the ink-transfer wheel is preferably made of a non-porous, non-stick material that will easily release the ink, thereby transferring it to the adhesive side of the tape, where it will permanently bond to the adhesive. The tape, with its newly formed functional strip 14, is then rolled on a core 12 producing a roll of tape 11.

Optionally, jets of hot air can be directed at the printed strip at strategic places 55, 56 to accelerate the drying of the ink (with vapor recovery if appropriate), thereby allowing increased production speeds. Similarly, the length of tape 56 between the ink-transfer wheel and the tape roll can pass through a drying oven (in the case of water- or solvent-based inks), or under an ultraviolet (UV) lamp (in the case of UV-cured inks).

An additional, optional pressure roller 43 can be utilized to augment the rolling of the tape onto its core.

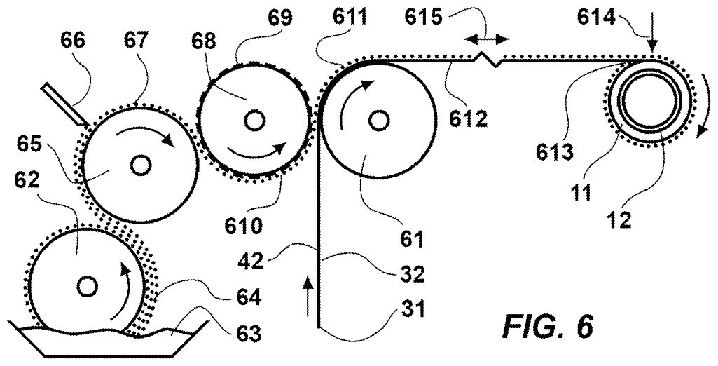

FIG. 6 shows a process for using a flexographic printer to produce the functional strip in the present invention. The adhesive base tape to be printed 31 has an adhesive side 32 and a backing side 42. The tape feeds onto a rotating impression cylinder 61. A fountain cylinder 62 rotating in the opposite direction is partially immersed in a tray of liquid ink 63. A thick layer of ink 64 adheres to the fountain cylinder and is brought into direct contact with an anilox cylinder 65 rotating in the opposite direction. A thinner film of ink sticks to the anilox cylinder, and a doctor blade 66 scrapes off excess ink to leave a prescribed thickness of ink 67. The anilox cylinder presses up against a plate cylinder 68, which is clad with a curved printer plate 69, the raised surface of which is the mirror image of the design to be printed. A thin layer of ink 610 is transferred to the raised surface of the plate cylinder, from where it comes into contact with the tape backing 42 pressed up against the impression cylinder 61. A portion of the ink 611 is transferred to the tape, and the printed tape 612 is withdrawn from the impression cylinder 61, and wound onto a cardboard core 12 on a tape roller to form a roll of tape 11. As the printed tape winds up, the ink on the backing side of the tape comes into contact 613 with the adhesive side of the next layer of tape, where the ink layer bonds to the adhesive layer above. Optionally, a pressure roller can apply pressure 614 to facilitate this adhesion. The adhesion of the ink to the adhesive side of the layer above means that when the tape is peeled off the roll, the ink is permanently bonded to the adhesive side of the tape, as desired, and the backing side of the tape has no appreciable remaining ink.

The length of tape 615 between the plate cylinder and the tape roller can be varied to allow sufficient time for the ink solvent to evaporate, and may include passage through a drying oven, a UV curing unit, or the like.

This process requires that the backing side of the incoming base tape have a non-porous surface that will not bond to the ink. In a variation of this process, flexographic printing may be used to print permanently on the backing side of the base tape, for applications where the adhesiveness on the adhesive side has been reduced by an alternate means, or is not being reduced at all.

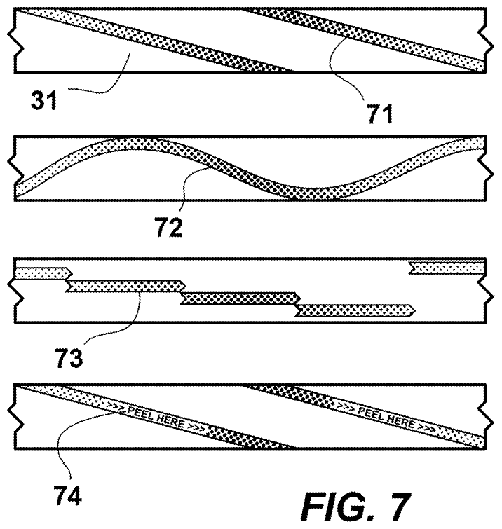

FIG. 7 shows some arrangements of the functional strip that vary in transverse position along the length of the tape. This may be desirable if the functional strip is created by a process that adds significant thickness, and the variation in transverse position prevents a bulge forming in one particular place across the tape, such as the center. In one example, the adhesive base tape 31 has an oblique functional strip 71 that creates a repeated cross-stripe effect. Another variation is a serpentine functional strip 72. The functional strip can also be discontinuous 73, and can, for example, convey information as to which direction the tape is wound, such as with the depiction of an arrow 73.

Text elements 74 can also be incorporated into the functional strip. Such text can be instructional, promotional, or thematic in nature.

### 2. Exemplary Embodiment

An exemplary embodiment of the invention, as depicted in FIG. 1, is transparent packaging tape 11 that is 50 mm (2 inches) wide wound on a 75 mm (3 inch) core 12, having a functional strip 14 that is, for example, 6 mm (¼ inch) wide, and is located at more-or-less the center of the tape. The present invention has full utility if the functional strip is off-center; however, it is likely more aesthetically pleasing to the user if the functional strip is approximately centered on the base tape, thereby providing some symmetry. For the purposes of this and other embodiments, the term transparent means that a typical user of the tape can see through it to sufficient degree that they can readily detect any modification of appearance that has been made to the underside of the tape.

In this embodiment, the functional strip has a modified appearance created by a colorizing agent, such as ink, present on the underside (adhesive side) of the tape, the coloration of which can be seen clearly from the top side of the transparent tape. This modified appearance provides a contrasting appearance between the functional strip and the clear tape adjacent to it, making it easy to detect where the functional strip is. The modified appearance also incorporates a changing appearance in the longitudinal direction in the form of a gentle color gradient, such that on each revolution around the roll, the color is significantly different from that of the layer immediately beneath it. One example is a rainbow gradient that repeats every 1 m (40 inches) or so. The circumference of the tape on the roll (depending on how much tape has been used) is typically 250 to 350 mm (10 to 14 inches), so each revolution will transition through about one quarter or one third of the rainbow. Accordingly, when the color of the functional strip at the leading edge of the tape is, say, blue, the layer immediately below it, to which it adheres, might be yellow—making locating of the leading edge very simple.

In this exemplary embodiment, the tape within the functional strip is 80% less adhesive on the underside, making it easier to lift and peel, for example, by inserting a fingernail under the leading edge within the width of the functional strip, as shown in FIG. 2. A thick layer of ink on the underside of the tape can completely mask the adhesiveness of the tape wherever the ink is present. In order to provide 80% reduction in adhesiveness (rather than 100% reduction), in this embodiment the ink within the functional strip has only 80% coverage utilizing, for example, a dot-matrix pattern with 20% of the area being ink-free.

### 3. Other Embodiments

Other embodiments of the present invention may use alternative coloration techniques to the exemplary embodiment when it comes to the modified appearance of the functional strip. These can affect either or both of the components of the modified appearance, namely, the contrasting appearance, and the changing appearance in the longitudinal direction.

In the preferred embodiment, the changing appearance in the longitudinal direction is created by a gentle color gradient, which has been created by a change in hue of the ink.

Other approaches to the changing appearance in the longitudinal direction may be used, provided the appearance on any particular revolution around the roll is significantly different from the appearance of the layer immediately beneath. The desired result can be achieved using variations in, for example, color saturation, lightness/darkness, opacity/translucency, or through the use of patterns or visual textures that fluctuate enough for the leading edge to be easily discerned. The coloration utilized can incorporate multiple colors, such as from a 4-color printing process, or may utilize a single color. For the purposes of the coloration creating this changing appearance, black, white and transparent are considered to be colors.

The coloration applied to create the modified appearance may also include the presence of text, icons or other symbols, either for informational or aesthetic purposed. For example, text within the functional strip may say “Peel Here”, and an arrow may indicate which direction the tape was wound as a hint as to which way to peel. Text, icons or other symbols may be used, for example, to convey: product branding; websites for ordering; promotions and advertising; themed content, such as seasonal or holiday designs; and other customizations with third party content.

In the preferred embodiment, the coloration was applied to the underside (adhesive side) of a transparent base tape. The same utility, with respect to the modified appearance of the functional strip, can be accomplished by applying coloration to the topside (backing side) of the tape. This can be done for base tapes that are translucent or opaque, wherein the modified appearance might not be readily visible through the tape if it were applied to the underside. Coloration on the topside can also be used for a transparent base tape in situations where the adhesiveness on the underside is not being reduced by the presence of the colorizing agent that produces the modified appearance.

In the preferred embodiment, the colorizing agent is ink, for example, that has been printed onto the adhesive side of the tape. Herein, the term ink is intended to include dye, stain, paint, pigment, and any similar liquid colorizing agent. Other potential colorizing agents include colored powders, chemical treatments, radiation treatments, thermal treatments, or any other media or method that can alter the appearance of a flat surface.

Another preferred embodiment utilizes a composite material comprised of the base tape and a second thin film with the desired width and properties of the functional strip, said second thin film having been bonded to either the adhesive side or the backing side of the base tape. This second thin film may be a polymer, paper, metal foil, or any other material in thin-film form. If it is bonded to the adhesive side of a transparent base tape, its exposed surface on the underside should possess the desired adhesiveness of the functional strip, and its nonexposed surface, visible through the transparent tape, should possess the desired coloration of the functional strip. If this second thin film is bonded to the backing side of the base tape, its exposed upper surface should possess the desired coloration of the functional strip, and any reduction in adhesiveness on the underside should be accomplished by a secondary means.

If the modified appearance of the functional strip comes from a layer of ink (or similar colorizing agent) or from a second thin film bonded to the base tape, it involves the addition of new material to the base tape. This added new material will invariably add thickness to the base tape in the zone of the functional strip. In the case of ink, that added thickness might be as low as about 1 micron (0.04 mils), whereas in the case of a second thin film bonded to the base tape, the added thickness may be 25 microns (1 mil), or more. The degree of added thickness has implications for both the method of manufacture, and the choice of the lateral placement of the functional strip, with a variable lateral placement being appropriate when the added material adds significant thickness.

Any embodiment of the present invention may include coloration effects outside of the functional strip that inadvertently aid in finding the leading edge. For example, packaging tape is sometimes printed on the backing side to deliver a branding or promotional message across the full width of the tape. Depending on the nature and complexity of the design, this may help in locating the leading edge. In this example, the present invention would entail modifying that design to highlight where, laterally, the functional strip is located (so that the reduced adhesiveness in that zone can be utilized), and may, optionally, also modify the design to make the leading edge stand out even more.

In the preferred embodiment, the functional strip is located at the center, and always lays on top of itself, necessitating the changing appearance in the longitudinal direction. The present invention also allows for embodiments where the strip varies in its transverse location, as shown in FIG. 7. Embodiments using variable strip locations reduce or eliminate the need for any changing appearance in the longitudinal direction, provided the uppermost functional strip does not lie immediately on top of the functional strip on the layer of tape below (or the second or third layer below that). In such embodiments, there is a sudden discontinuation of the functional strip at the leading edge, said discontinuation being apparent because of the contrasting appearance between the functional strip and the base tape below it, to which it adheres. Hence, of the two components of the modified appearance, these embodiments only require one of them, being the contrasting appearance with the base tape.

In the preferred embodiment, the functional strip is located at the center. In one possible variation of this embodiment, the changing appearance in the longitudinal direction (while still occurring within the functional strip) may extend outside of the functional strip and across the entire width of the tape. In this instance, only one of the two components of the modified appearance, namely the changing appearance in the longitudinal direction, is being utilized. The contrasting appearance is not being utilized, as it may not be needed. In this case, as the functional strip is always located at the center, users can be directed to peel the tape at the center, where adhesiveness has been reduced to make it easier to peel. These instructions may be provided on the tape itself, or on the packaging or product literature.

Other embodiments of the present invention may use alternative approaches to the exemplary embodiment when it comes to the degree of reduced adhesiveness within the functional strip.

The primary function of the reduced adhesiveness is to make it easier to lift and peel the leading edge. For a typical thin, highly-adhesive packaging tape, the average user has difficulty lifting and peeling the leading edge the majority of the time. Hence, a significant reduction in adhesiveness is appropriate. The precise degree that is optimal depends on both the adhesiveness and thickness of the tape, the latter determining how much purchase the user can gain with their fingernail (or other object) to pry the leading edge free from the roll of tape. In tests with a range of commercially popular packaging tapes in the US, noticeable benefits were seen at about 25% reduction in adhesiveness, with clear benefits being apparent at about 50%. These percentages are not precise, and are not prescriptive, and can be different for every type of tape. A practitioner of this invention should assess the ease with which their base tape can be peeled, and then test varying degrees or reduction in adhesiveness until they find a preferred degree.

Clear advantages in the ease of peeling were observed when the degree of reduction in adhesiveness was 100%, particularly when this was achieved by not having any adhesive compound present in the area of the functional strip (as opposed to masking it with a layer of added material). The absence of adhesive compound meant the there was a thin air gap occupying the space where that adhesive would have been, making it easier to get a fingernail or other item under the leading edge. While 100% reduction means that the tape is no longer adhesive within the functional strip, this may be acceptable with regard to the overall adhesiveness of the tape provided the strip does not occupy more than, say, 20% of the tape's area. In box-sealing applications, the centerline of the tape often falls over the small gap between box sides or flaps, and hence minimal adhesiveness at that position is of little detriment. The reduction in adhesiveness of 100% considered here is not meant to be precise, and anything approaching 100% reduction can be considered to be effectively 100% reduction.

There are some embodiments where the present invention might be applied to a base tape wherein the thickness is high enough and/or the adhesiveness is low enough that the tape, in its unaltered base form, is easy to lift and peel at the leading edge. In this instance, the present invention provides the added utility of ease of location of the leading edge, while the degree of reduced adhesiveness could be effectively 0%. Furthermore, with little or no reduction in adhesiveness, the functional strip can be made wider with no detriment to the overall adhesiveness of the tape, hence it may occupy most or all of the width of the tape. However, in keeping with the observation that consumers overwhelmingly prefer their packaging tape to be transparent, a narrow, more subtle function strip along the centerline may still be preferred when no reduction in adhesiveness is applied.

The present invention has many possible embodiments with respect to reduced adhesiveness. As a first example, there can be less adhesive compound or no adhesive compound on the backing film within the functional strip. This may have been accomplished by modifying the method of producing the base tape, or by removing some or all of the adhesive compound from the base tape in a post-production step. This first example results in there being less matter within the functional strip. As a second example, there can be partial coverage or full coverage of the adhesive surface with a masking material (such as ink) that has either less adhesiveness, or no adhesiveness. By varying the adhesiveness and degree of coverage of this masking material, any degree of reduced adhesiveness can be attained within the functional strip. This second example results in there being more matter within the functional strip. As a third example, the adhesive layer can have reduced adhesiveness on its surface, having been accomplished by, for example, chemical reaction, radiation treatment, or any other physical treatment that alters the chemical nature of the surface. This third example results in there being no significant change in the amount of matter within the functional strip.

Other embodiments of the present invention may use alternative geometry to the exemplary embodiment when it comes to the dimensions and placement of the functional strip. The key geometric considerations are: 1) the width of the functional strip with respect to both the modified appearance and the area of reduced adhesiveness; 2) its lateral positioning across the width of the tape, and any variability thereof; and 3) any change in thickness of the base tape that the reduced adhesiveness and/or modification in appearance may produce.

The preferred embodiment has a functional strip that is 6 mm (¼ inch) wide. This is wide enough to easily insert a fingernail and begin peeling, and narrow enough to not reduce the overall adhesiveness of the tape by too much. In other embodiments, the functional strip may be made narrower, such as 3 mm (⅛ inch) wide, in order to have less reduction in the overall adhesiveness of the tape at the expense of being slightly more difficult to lift the leading edge with a fingernail. This might be particularly advantageous for sticky tape, where the base tape is only, say, 13 mm or 19 mm (½ inch or ¾ inch) wide. In contrast, the strip may be made wider, for example 20 mm wide, to allow more visually compelling designs, or the printing of branding or information. In packaging tape applications, adhesiveness is more important along the edges of the tape than it is near the center, so such a wide strip would not greatly impact its utility if placed at the center.

The present invention allows for a situation where the width of the modified appearance is not identical to the width of the area where the adhesiveness has been reduced. For example, a 6 mm (¼ inch) wide zone of reduced adhesiveness may have a 3 mm (⅛ inch) wide strip opposite it and laterally concentric with it wherein the appearance has been modified. Or, in contrast, the modified appearance may be a 20 mm (0.8 inch) wide strip, all else being equal. Furthermore, the widths of any and all features of the functional strip may fluctuate longitudinally while still delivering full benefits of the present invention.

While one preferred location of the strip is at the center of the tape and parallel to the tape, it can in fact be located anywhere. There is some aesthetic appeal to locating it in the center, however it may change location longitudinally, in, for example, an angled fashion, a serpentine manner, or a discontinuous pattern as shown in FIG. 7. This may be done for alternate aesthetic reasons, or may be done to prevent a bulge from being produced by the added thickness of the colorizing agent, whether it be on the topside or underside of the tape.

With respect to this bulge, consider the following two examples. In the first example, the functional strip comprises a 1 micron (0.04 mil) thick layer of ink bonded to the adhesive side of the tape. The tape comprises a 37-micron (1.5 mil) backing film coated with a 13 micron (0.5 mil) layer of adhesive compound, for a total thickness of 50 microns (2 mils). At the point on the roll of tape where there are 200 revolutions of tape (which would be 10 mm or 0.4 inches thick on the roll), the added thickness of 200 layers of ink would produce a bulge of 200 microns (8 mils), or the equivalent of 4 layers of tape. This could cause the tape to crease and deform slightly on the roll, creating a slightly inferior product.

In the second example, all parameters are the same as the first example except that the functional strip comprises a second thin film bonded to the adhesive side of the tape, said second thin film having a thickness of 25 microns (1 mil). In this case, the added thickness of the bulge after 200 revolutions would theoretically be 5 mm (0.2 inches), which would likely make it impossible to roll up the tape without creasing or other unacceptable irregularities.

In both of these examples, the problem can be alleviated by varying the lateral position of the functional strip along the length of the tape. This would mean that the added material would be dispersed more-or-less evenly across the width of the tape, producing no bulge.

When using a pattern that slants or weaves across the width, as in the oblique functional strip 71 in FIG. 7, the periodicity and slant of the pattern may be prescribed so that as each revolution of tape is wound up, the pattern falls just short of, and not directly on top of, the functional strip of the layer below. In this fashion, there will not be a situation where the pattern overlays itself in consecutive layers, which may cause obscuring the leading edge. If correctly prescribed, this geometry may mean the slanting pattern does not directly overlay itself for a dozen or more layers of tape, such a situation being beneficial.

In some alternative embodiments, the reduction in adhesiveness occurs due to there being less adhesive compound or essentially no adhesive compound within the zone of the functional strip. This causes a reduction in the thickness of the base tape within the functional strip. This can be used to benefit if the colorizing agent, such as ink, is applied within the confines of that zone. Provided the ink's thickness as the same or less than the decrease in adhesive thickness within the functional strip, it will cause no bulge at all.

A variation on that theme is described by the following embodiment. A functional strip could comprise a 6 mm (¼ inch) wide zone down the center of the strip where there is no adhesive compound on the tape backing, producing 100% reduction in adhesiveness. In this example, the adhesive layer elsewhere on the tape is 13 microns (0.5 mil) thick. Opposite this strip, a layer of ink is bonded to the tape backing. It too is 13 microns (0.5 mil) thick and 6 mm (¼ inch) wide, or perhaps a little less to give some leigh way in positioning. As the tape is rolled up, the risen strip of ink on the backing fits nicely into the recessed strip above where there is no adhesive—thereby eliminating any bulge.

Other embodiments of the present invention may use different forms of base tape to the exemplary embodiment.

While the preferred embodiment applies to packaging tape, aspects of the present invention can be applied to any kind of adhesive or semi-adhesive tape, or any kind of material that is a thin adhesive film in rolled form. Examples include duct tape, electrical tape (or insulating tape), filament tape (or strapping tape), gaffer tape, hockey tape (or friction tape), masking tape, or transparent office tape.

As an example of a different application, consider masking tape produced for children's projects and entertainment. Masking tape is designed to have low-enough adhesiveness that it can be applied to a clean, smooth surface and then removed easily without leaving a mark. It has a paper backing film so it can be easily torn by hand. For masking tape products marketed for children's use, the tape is usually brightly colored, often with whimsical patterns. Despite the patterns and low adhesiveness, younger children often struggle to fine and peel the leading edge, and are constantly seeking assistance from their parents. The present invention, perhaps with a 3 mm (⅛ inch) wide functional strip, would be efficacious for such an application.

Other variations of the present invention may create a variety of other embodiments. For example, a coloring agent could be utilized during manufacture of the backing film, resulting in the modified appearance being an integral part of the backing film, be it opaque or transparent. As another example, the coloring agent could be applied to a transparent backing film before the adhesive compound is applied. The adhesive compound could then be wiped onto the modified backing (on the same side as the coloring agent) as hot melt, and that would leave a thinner layer of adhesive over the raised layer of colored material. The result would be a decrease in the amount of adhesive compound applied to the backing film within the area of the functional strip, the degree of said decrease contributing to the degree of reduced adhesiveness within the functional strip.

In another embodiment, the functional strip may be created by a complete absence of adhesive, which in and of itself, may provide sufficient visual clues to locate the strip and find the leading edge.

### 4. Exemplary Methods of Manufacture

Methods and processes for producing the present invention, for example in the exemplary embodiment described herein, may be implemented either 1) as an additional step in the general manufacture of adhesive tape, or 2) as a post-production step applied to a base tape that has already been produced, perhaps on intermediate-sized spools.

The general manufacture of pressure-sensitive adhesive tape, such as packaging tape, is done by the following or similar process. It begins with a large roll of polymer film, such as an 800 m length of 0.05 mm (2 mil) thick polypropylene film on a 1.5 m (5 ft) wide roll. The film can be opaque, transparent, or translucent, and can be colored or natural.

The roll of film is mounted on an unwinder, which delivers the rapidly moving film under tension control to a gluer. The gluer wipes a thin, controlled layer of the adhesive compound, in the form of a hot melt, onto one side of the film, said hot melt being typically at, say, 200° C. (400° F.). The adhesive compound might comprise, for example, the following components: synthetic rubber; synthetic resin adhesive; a UV protector; an antioxidant; and optional pigments to color the tape so produced. In another variation of this step, the adhesive compound is dissolved in a solvent to produce a viscous liquid, which is wiped or sprayed to form a thin layer on the backing film, following which the solvent is evaporated leaving the adhesive layer behind (with radiation curing as an optional post-treatment step).

Following the gluer, the 1.5 m (5 ft) wide tape passes, adhesive side out, over a cooling roller, which causes the adhesive layer to rapidly cool and harden. A rewinder then rolls it back up onto large spools for further processing.

The next step is to feed these large spools into a slitter, where razor knives slit the web of tape into the desired widths, such as 50 mm (2 inches) for common packaging tape. The slitter then rolls prescribed lengths, such as 50 m (55 yards), onto cardboard cores, which are typically 75 mm (3 inches) in diameter, producing a final consumer product. It is before or during this last phase of production that the methods and processes of the present invention would most likely be implemented.

A tape manufacturer may also produce intermediary products to sell to light industry for further enhancement, such as custom printing or specialty treatments. For this, the slitter may be set to produce, for example, intermediate-sized spools of tape (e.g., 1000 m or 3,300 ft in length) that are, say, 300 mm (12 inches) wide. The methods and processes of the present invention could easily be incorporated into the other enhancements already being performed by these light manufacturers.

One of the post-treatments often performed on adhesive tape is corona treatment, a surface modification technique that uses a low temperature corona discharge plasma to impart changes in the properties of a surface on the backing side of the tape. In this context, it is used to increase the surface energy of the tape backing to make it more amenable to accepting ink during the flexographic printing process. If the processes shown in FIG. 4, FIG. 5 or FIG. 6 are used, this process might be best avoided so that the ink does not bond too well to the tape backing. In fact, surface treatment with a release agent, such as siloxane, may be required for some backing-film materials. If, however, the modified appearance of the functional strip is produced by printing ink permanently onto the backing side of the tape, then corona treatment would be beneficial.

In order to produce the exemplary embodiment described herein, both the modified appearance and the reduction in adhesiveness can be produced by the application of a layer of colored ink onto the adhesive side of the transparent base tape within the zone of the functional strip. Four exemplary methods or processes are described here for accomplishing this. While these processes are depicted in FIGS. 3-6 with a single roll of tape being produced, the processes can each be applied to wider webs of tape. As an example, any of the processes could be used to print six functional strips on a 300 mm (12 inch) wide web of tape, prior to it being slit and rolled into six individual rolls of tape. All exemplary processes and variations described herein are subject to this same extension of scale. Furthermore, while these processes are depicted in FIGS. 3-6 with a single printer head or printer plate, it is implied that multiple heads or plates could be employed to produce multiple colors and/or multiple functional strips.

The first exemplary method of manufacture involves printing the functional strip directly onto the adhesive side of the tape by means of any non-contact printing method that sprays or otherwise delivers a colorizing agent without directly contacting the surface. A preferred example of a non-contact printing method is an inkjet printer. An inkjet printer head could be positioned, as shown in FIG. 3, with a 1 mm (0.04 inch) gap between it and the moving adhesive layer below.

Inkjet printing in this context lends itself to the use of solvent-based ink that will dry quickly and allow for rapid production techniques. In experiments using solvent-based inkjet printing, print qualities were high and adhesion of the ink was excellent using several commercially available packaging tapes as a base tape. Varying the ink density allowed for any degree of reduction of the adhesivity within the functional strip, up to and including effectively 100% reduction. In these trials, the usability of the product was further enhanced by embedding arrows and text into the functional strip to indicate which way the tape was rolled up—hence, which way to peel to unroll it. Any printed messages, if produced by this method, need to be printed in mirror image, so that they read correctly when viewed through the transparent backing film.

The second exemplary method, as shown in FIG. 4, involves applying the ink to the adhesive side of the tape by an indirect means in order to avoid printer heads from getting close to a rapidly moving adhesive surface. In this method, the ink is printed initially onto the non-adhesive backing side of the tape, and then transferred to the adhesive side of the tape where it permanently bonds. Whereas the first exemplary method required the strip design to be printed in mirror image, this method does not, as the image becomes reversed during this second step.

In this second method, as shown in FIG. 4, pressure from a pressure roller helps transfer the ink, and helps avoid bulging as the roll of tape is wound up.

This method has limitations in the format shown in FIG. 4, as the speed of the tape 47 would have to be low enough that the ink has time to dry to an acceptable degree prior to winding up. A variation that could avoid this limitation would have the tape first pass over an intermediate roller, adhesive side down, with a print head positioned above said roller, in a similar fashion as was shown in FIG. 3 (but with the adhesive side down). This would allow for a longer distance between the print head and the rolling up of the tape, facilitating longer ink-drying times and faster tape speeds. This would also allow the tape to pass through a drying oven or UV-curing unit, if applicable, prior to being rolled up.

The third exemplary method also involves indirect printing using an ink-transfer wheel, as shown in FIG. 5. The ink is first printed onto the ink-transfer wheel, which then brings the ink into direct contact with the adhesive side of the tape, depositing the ink permanently onto the adhesive surface. There are some options to enhance this process.
1) The ink-transfer wheel can be heated to speed up the ink drying process.
2) The ink-transfer wheel can be sized independently of the roll of tape, with larger ink-transfer wheels resulting in longer ink-drying times prior to being transferred to the tape.
3) Rather than an ink-transfer wheel, an ink-transfer blanket can be utilized, as is sometimes used commercially in digital offset printing.

The outer surface of the ink-transfer wheel should be made of a material that readily accepts the ink without beading or bleeding, but that also releases the ink completely when it comes into contact with the adhesive side of the tape. Material selection should be non-porous, and should probably be oleophilic for solvent-based inks, or hydrophilic for water-based inks.

The fourth exemplary method of manufacture is another indirect printing means, this time based on the well-established flexographic printing technique, as shown in FIG. 6. Flexographic printers are already used commercially to print ink onto the backing layer of a wide range of adhesive tapes, including packaging tape. This method modifies the standard flexographic printing process to produce a functional strip on the adhesive side of the tape.

In a variation of the process in FIG. 6, the tape so produced is initially wound on a spool rather than on its final cardboard core. The tape so produced is then unwound to allow the ink to be released from the backing and transferred to the adhesive side in a timely fashion, following which it can be rewound onto its final core.

In a second variation of the process in FIG. 6, the backing film is corona treated, or any similar process is used, so that it readily accepts the ink, which permanently bonds to the backing side, and does not transfer to the adhesive side. In this case, when the tape is peeled from the roll, the ink is still bonded to the backing side of the tape. In this second variation, any reduction in adhesiveness must be accomplished by a secondary means. Said secondary means can include, for example: the solvent removal of some or all adhesive in a post-production step; the masking of some adhesiveness by bonding a non-adhesive material onto part or all of the adhesive surface; or the production of a base tape with less (or no) adhesive compound within the zone of the functional strip.

### 5. Other Methods of Manufacture

There are some other variations and considerations with respect to the methods of manufacture of the present invention.

The preferred embodiment described herein has 80% reduction in the adhesiveness within the functional strip. This can be accomplished by printing a thick layer of ink onto the adhesive side of the base tape with 80% coverage of ink, whereby a pattern is printed in which 20% of the area does not receive any ink. Alternatively, ink can be printed with full coverage but with a light enough coating of ink that it does not completely mask the adhesiveness, and wherein about 20% adhesiveness remains.

The reduction in adhesiveness of the base tape can also be accomplished by non-printing methods. Examples include: chemical modification to react a reagent, such as a monomer, with the exposed adhesive surface rendering it less adhesive; radiation to induce crosslinking of one or more of the adhesive compound's components; corona treatment; or physical removal of some or all of the adhesive compound, with or without the aid of a solvent.

The reduction in adhesiveness of the base tape can also be accomplished by modifying the initial production process for the base tape in, for example, the following way. During the production step where the gluer wipes a thin, controlled layer of hot melt onto one side of the backing film, the blade-edge that does the wiping can have raised sections where the desired functional strips will be, such that a reduced amount of hot melt is wiped onto the film at those locations. A typical PSA tape might have an adhesive layer that is, say, 100 microns (4 mils) thick. The wiping blade might have, for example, a raised section 6 mm (¼ inch) wide every 50 mm (2 inches) across the width of the 1.5 m (5 ft) incoming film, such raised sections being raised by 75 microns (3 mils). This would reduce the thickness of the adhesive layer in these zones from 100 microns (4 mils) to 25 microns (1 mil), significantly reducing the adhesiveness in the 6 mm (¼ inch) wide strips. This would, in turn, allow the final tape to be slit into 50 mm (2 inch) wide rolls each having a 6 mm (¼ inch) wide strip at its center with reduced adhesiveness. Similar techniques could be employed when utilizing solvent-based liquid adhesive compounds in the manufacturing process.

Although the focus of the exemplary processes described herein, with reference to FIGS. 3-6, are on printing as the preferred method of producing the modified appearance required for the present invention, there are other techniques that can be used instead of or in conjunction with printing. These include heat treatments, radiation, laser treatment, etching, chemical modification, or any other process that can be used to modify the appearance of a film of material. The base tape to be modified may be produced as a composite film wherein the outer layer on the backing side is made of a composition amenable to any of these alternative colorizing agents or methods.

One alternate embodiment described herein comprises a composite of a base tape and a second thin film bonded to said base tape, said second thin film providing the modified appearance and/or reduced adhesiveness of the functional strip.

The second thin film may itself be a narrow form of adhesive tape, with appropriate coloration and an adhesive underside as part of its composition. This narrow tape would be applied to the underside of a transparent adhesive base tape in the desired location prior to or while the new composite tape is being rolled up. If rolled concurrently, a spool could feed this narrow second tape in a transversely oscillating fashion so that its position varies across the width of the base tape as the two tapes are rolled up.

It would be preferable that the second thin film can tear easily. Consider, for example, packaging tape produced with a second thin film creating the functional strip. If this packaging tape were intentionally notched (or punctured, as with a pen) so it could be torn rather than cut with scissors, it would be advantageous if the second thin film could tear along with the base tape. This ability to tear could be increased by giving the second thin film a finely serrated edge, representing a continuum of built-in notches to facilitate tearing at any point.

The various methods of manufacture described herein can utilize a pressure roller to apply pressure to the tape as it is rolled up on its core, sometimes as a means of preventing a bulge from occurring due to any added new material in the form of ink, a second thin film, and the like. The use of such a pressure roller at low pressure is not uncommon when rerolling tape during manufacture, ensuring that the tape does not wrinkle, crease or trap air bubbles as it rolls up. U.S. Pat. No. 5,755,905 (Sinn, 1998) describes the use of such a pressure roller at much higher pressure than normal to create a “transparent to the core” roll of tape. Sinn's results show that using pressures in the range of about 10 to 30 pounds-per-linear-inch (PLI) created his desired results, whereas standard industry pressures of 1 to 4 PLI did not. The present invention may use pressures anywhere from industry standards (1 to 4 PLI) up to and including Sinn's prescribed range (>10 PLI), with or without the added feature of being transparent to the core. The approximate amount of pressure required for the present invention will depend on the compositions and dimensions of the base tape and the added material, be it ink, a second thin film, or anything else. It is likely that pressures in the range Sinn prescribes, namely greater than 10 pounds per linear inch, will prove the most useful.

1. Adhesive tape on a roll comprising:
a base tape comprised of a backing film to provide strength and a layer of adhesive compound on one side of the backing film to provide adhesiveness; and
a functional strip running the length of the tape and occupying a portion of the width of the tape, wherein the tape within said functional strip comprises:
a degree of reduced adhesiveness; and
a modified appearance comprising at least one of:
a changing appearance in the longitudinal direction which, at any point along the tape, makes the functional strip appear noticeably different from the layer of tape immediately below it, to which it adheres on the roll; and
a contrasting appearance that makes the functional strip visually discernable from the base tape in its proximity.

2. The adhesive tape according to claim 1 wherein said modified appearance comprises both said changing appearance in the longitudinal direction and said contrasting appearance.

3. The adhesive tape according to claim 1, wherein the adhesiveness within the functional strip has been reduced by more than 25%, and preferably by more than 50%.

4. The adhesive tape according to claim 1, wherein the width of the functional strip is preferably between 3 mm and 10 mm.

5. The adhesive tape according to claim 1, wherein the transverse location of the functional strip is approximately at the center of the tape.

6. The adhesive tape according to claim 1, wherein the transverse location of the functional strip varies along the length of the tape.

7. The adhesive tape according to claim 1, wherein the degree of reduction in adhesiveness within the functional strip is effectively 100%.

8. The adhesive tape according to claim 1, wherein the degree of reduction in adhesiveness within the functional strip is effectively 0%.

9. The adhesive tape according to claim 1, wherein the area within the functional strip includes visible representations of information in the form of at least one of text, symbols and icons.

10. A method of producing the adhesive tape according to claim 1 comprising:
the step of applying the adhesive compound to the backing film to produce the base tape, said backing film being transparent and said base tape so produced having a degree of transparency;
and further comprising the step of depositing a layer of material onto the adhesive side of said base tape within the area of the functional strip, said layer of material having coloration and a degree of coverage, said degree of coverage contributing to the degree of reduced adhesiveness, and said coloration contributing to the modified appearance, said degree of transparency of the base tape being sufficient that the modified appearance is visible through the tape.

11. The method according to claim 10, wherein said deposited layer of material is a pre-formed film of material.

12. The method according to claim 10, wherein said deposited layer of material is a colorizing agent.

13. The method according to claim 12, wherein said colorizing agent is ink.

14. The method according to claim 13, wherein the ink is printed directly onto the adhesive surface of the base tape using a non-contact printing process such as inkjet printing.

15. The method according to claim 13, wherein the ink is printed temporarily onto the backing side of the tape and then transferred permanently to the adhesive side of the tape as the tape is rolled up.

16. The method according to claim 13, wherein ink is printed temporarily onto an ink-transfer surface from which it is then transferred permanently to the adhesive side of the tape by means of direct contact.

17. A method of producing the adhesive tape according to claim 1, comprising:
the step of applying the adhesive compound to the backing film to produce the base tape;
and further comprising the step of utilizing a means of colorization to colorize the backing side of said base tape, the coloration so produced contributing to the modified appearance within the functional strip.

18. The method of producing the adhesive tape according to claim 17, wherein the means of colorization is printing with ink.

19. The method of producing the adhesive tape according to claim 10, wherein the amount of adhesive compound applied to the backing film is decreased within the area of the functional strip, the degree of said decrease contributing to the degree of reduced adhesiveness within the functional strip.

20. The method of producing the adhesive tape according to claim 17, wherein the amount of adhesive compound applied to the backing film is decreased within the area of the functional strip, the degree of said decrease contributing to the degree of reduced adhesiveness within the functional strip.

21. The method according to claim 10, wherein a pressure roll is utilized to apply pressure to the backing side as the tape is rolled up, said pressure being greater than 4 and preferably greater than 10 pounds per linear inch.

22. The method according to claim 17, wherein a pressure roll is utilized to apply pressure to the backing side as the tape is rolled up, said pressure being greater than 4 and preferably greater than 10 pounds per linear inch.
